(19) United States
(12) Patent Application Publication
(10) Pub. No.: US 2026/0260027 A1
(43) Pub. Date: Sep. 3, 2026

(54) Method for Establishing Multi-Degree-of-Freedom Bending-Shear Coupling Nonlinear Analysis Model and Method for Applying the Model

(71) Applicant: GANSU URBAN AND RURAL PLANNING AND DESIGN RESEARCH INSTITUTE CO., LTD., Lanzhou, Gansu (CN)

(72) Inventors: Zhonghui LI, Lanzhou, Gansu (CN); Jia RUI, Lanzhou, Gansu (CN); Chunhao WANG, Lanzhou, Gansu (CN); Xiang YAN, Lanzhou, Gansu (CN); Liming LIU, Lanzhou, Gansu (CN)

(73) Assignee: GANSU URBAN AND RURAL PLANNING AND DESIGN RESEARCH INSTITUTE CO., LTD., Lanzhou, Gansu (CN)

(21) Appl. No.: 18/863,677

(22) PCT Filed: May 13, 2024
(86) PCT No.: PCT/CN2024/092923

§ 371 Date: Nov. 7, 2024

(30) Foreign Application Priority Data
May 23, 2023 (CN) 202310584905.7

(51) Int. Cl. G06F 30/13; G06F 30/20; G06F 119/14

(52) U.S. Cl. CPC G06F 30/13; G06F 30/20; G06F 2119/14

(57) ABSTRACT

A method for establishing a multi-degree-of-freedom bending-shear coupling nonlinear analysis model and a method for applying the model are provided. Collected building information is counted and analyzed; floor mass and floor moment of inertia of the building are calibrated by a mass and moment of inertia matrix; based on different types of the building structures, a proportion of the bending stiffness and a proportion of the shear stiffness of each floor of the building are different; global damping of the building is calibrated by a global damping matrix based on the processed building information; the global elastic rigidness of the building is calibrated by a global elastic rigidness matrix; a weight of the shear stiffness matrix and a weight of the bending stiffness matrix in the global elastic stiffness matrix are controlled; and a multi-degree-of-freedom bending-shear coupling model is established.

### TECHNICAL FIELD

The disclosure belongs to the technical field of civil engineering, and relates to a method for establishing a multi-degree-of-freedom bending-shear coupling nonlinear analysis model; and the disclosure further relates to a method for applying the multi-degree-of-freedom bending-shear coupling model, which established by the method, for simulating earthquake time-course response of an urban building complex.

### BACKGROUND

A multi-degree-of-freedom nonlinear analysis simplified model commonly used at present includes a multi-degree-of-freedom concentrated mass shear layer model and a bending-shear coordination model provided by Xin-Zheng Lu. A shear layer model is mainly configured to simulate a multi-floor building structure with a small aspect ratio, and usually shows an obvious shear deformation mode. The shear layer model assumes that the mass of each floor of the multi-floor building structure is concentrated on slab, considers the slab to be rigid and ignores rotational displacement of the slab, and simplifies each floor into a mass point, and the mass points among different floors are linked together through shear springs. The bending-shear coordination model is mainly used for a high-rise building in a city, such as a high-rise reinforced concrete frame-shear wall structure and a frame-core tube structure. The bending-shear coordination model disperses each floor of the building into a nonlinear bending spring and a nonlinear shear spring, and the bending spring and the shear spring of each floor are connected by a rigid chain rod. Compared with the shear layer model, the bending-shear coordination model is mainly configured to show bending deformation of the high-rise building, but cannot be configured to rapidly analyze anti-seismic performance of the building, earthquake damage simulation of a city or a village and early planning of the city.

### SUMMARY

An objective of the disclosure is to provide a method for establishing a multi-degree-of-freedom bending-shear coupling model for rapidly analyzing anti-seismic performance of a building.

Another objective of the disclosure is to provide a method for applying multi-degree-of-freedom bending-shear coupling model established by the above method.

In order to realize the purpose, the technical solution adopted by the disclosure is: a method for establishing a multi-degree-of-freedom bending-shear coupling model includes the following steps.
Step 1). collecting basic building information of buildings in a building complex, and processing the basic building information by a probabilistic statistical method to obtain building information for calculation.
Step 2). calibrating floor mass and floor moment of inertia of the building are calibrated by a mass and moment of inertia matrix according to the building information for calculation, simplifying each floor of the building into a two-dimensional flat plate, connecting two sides of an upper flat plate and a lower flat plate adjacent through a shear spring, connecting the centers of the upper flat plate and the lower flat plate adjacent through a bending spring to obtain to a calculation model, the shear spring is configured to control a translational deformation characteristic of a physical model, and the bending spring is configured to control a bending deformation characteristic of the physical model; and the calculation model is configured to exhibit an actual deformation characteristic and anti-seismic performance based on relative magnitudes of bending stiffness of the bending spring and shear stiffness of the shear spring under interaction of the bending spring and the shear spring.

Dividing the building based on floor, wherein each building floor has corresponding bending stiffness and shear stiffness based on a structural characteristic of the building floor; based on different types of building structures, a proportion of the bending stiffness and a proportion of the shear stiffness of each building floor are different; and concentrating building mass of each floor onto the slab, replacing the corresponding shear stiffness of each floor by two nonlinear shear springs, and replacing corresponding bending stiffness of each floor by one nonlinear bending spring.

Calibrating global damping of the building by a global damping matrix based on the building information for calculation, and the global damping matrix includes a damping matrix related to translation displacement, a damping matrix related to node rotation and a damping matrix related to corner translation.

Calibrating global elastic stiffness of the building by a global elastic stiffness matrix based on the building information for calculation, and the global elastic stiffness matrix includes a shear stiffness matrix related to translation, a bending stiffness matrix related to corner, and a bending-shear coupling stiffness matrix related to corner translation;
determining a corresponding shear stiffness matrix coefficient α and a bending stiffness matrix coefficient β of each floor of the building based on the building information for calculation, and a weight of the shear stiffness matrix and a weight of the bending stiffness matrix in the global elastic stiffness matrix are controlled by α and β.
step 3). By taking the mass and moment of inertia matrix, the global damping matrix and the global elastic stiffness matrix as components, establishing a kinetic equation of the multi-degree-of-freedom bending-shear coupling model:

$$[ \begin{matrix}{M}_{hh} & 0 \\ 0 & {J}_{rr}\end{matrix} ] \{ \begin{matrix}\ddot{u} \\ \ddot{θ}\end{matrix} \} + [ \begin{matrix}{C}_{hh} & {C}_{hr} \\ {C}_{hr}^{T} & {C}_{rr}\end{matrix} ] \{ \begin{matrix}\dot{u} \\ \dot{θ}\end{matrix} \} + [ \begin{matrix}α {K}_{hh} & {K}_{hr} \\ {K}_{hr}^{T} & β {K}_{rr}\end{matrix} ] \{ \begin{matrix}u \\ θ\end{matrix} \} = - [ \begin{matrix}{M}_{hh} & 0 \\ 0 & {J}_{rr}\end{matrix} ] \{ \begin{matrix}e \\ 0\end{matrix} \} {\ddot{u}}_{g} \qquad ( 8 )$$

In formula (8), α is amplitude modulation coefficient of the shear stiffness in the stiffness matrix; β is amplitude modulation coefficient of the bending stiffness in the stiffness matrix; ü is acceleration unit: m/s²; \dot{θ} is angular acceleration, unit: rad/s²; \dot{u} is velocity, unit: m/s; \dot{θ} is angular velocity, unit: rad/s; u is displacement, unit: m; θ is corner, unit: rad; and ü_{g} is earthquake acceleration, unit: gal.

Another technical solution adopted by the disclosure is: a method for applying multi-degree-of-freedom bending-shear coupling model established by the above method in rapidly analyzing anti-seismic performance of a building, earthquake damage simulation of a city and earthquake damage simulation of a village.

The multi-degree-of-freedom bending-shear coupling model established by the establishing method of the disclosure may rapidly simplify modeling of a building complex based on structural form and related building characteristic of buildings in a regional building complex, and dynamic nonlinear time-course analysis is carried out on the established bending-shear coupling model to reflect inter-floor displacement, inter-floor displacement angle and inter-floor corner of the building. Compared with the multi-degree-of-freedom concentrated mass shear layer model and the bending-shear coordination model in the relevant art, the multi-degree-of-freedom bending-shear coupling model of the disclosure analyzes structures including the multi-floor building structure with small aspect ratio mainly having shear deformation and the frame-shear wall and the frame-core tube structure coupling shear deformation by adjusting the weight of the shear stiffness and the weight of the bending stiffness of the building based on the characteristic of the building structure. The multi-degree-of-freedom bending-shear coupling model may be configured to rapidly analyze anti-seismic performance of the building, earthquake damage simulation of a city or a village and early planning of the city.

The multi-degree-of-freedom bending-shear coupling model established by the establishing method of the disclosure and its kinetic nonlinear analysis mathematical expression parameter calibration method may show stress and deformation characteristic of the building structure system under action of earthquake by adjusting, calibrating and predicating the weight of the corresponding bending stiffness and the weight of shear stiffness in the overall stiffness of the structure based on different displacement response or deformation modes of different building structure systems under action of earthquake. The multi-degree-of-freedom bending-shear coupling model may rapidly reflect different earthquake damage characteristics and anti-seismic performances of buildings of different structure forms, and may obtain earthquake damage condition of each floor of each building according to the kinetic nonlinear analysis calculation result. The multi-degree-of-freedom bending-shear coupling model is small in calculation amount, to be suitable for earthquake damage simulation of buildings of city size.

### BRIEF DESCRIPTION OF THE DRAWINGS

FIG. 1 is an overall flowchart of an establishing method of the disclosure.

FIG. 2 is a bi-linear skeleton line of a bending spring and a flowchart of parameter calibration.

FIG. 3 is a bi-linear skeleton line of a shear spring and a flowchart of parameter calibration.

FIG. 4 is a schematic diagram of a bending-shear coupling model.

FIG. 5 is a curve chart of an input earthquake time-course of an embodiment of the disclosure.

FIG. 6 is a curve chart of inter-floor displacement of a high-rise building of an embodiment of the disclosure.

FIG. 7 is a curve chart of an inter-floor displacement angle of a high-rise building of an embodiment of the disclosure.

### DETAILED DESCRIPTION OF THE EMBODIMENTS

The disclosure will be described in detail below with reference to the drawings and implementation modes.

Earthquake damage analysis methods for an urban building complex include a vulnerability matrix method and earthquake response nonlinear course analysis method and apparatus for an urban building complex (Xin-Zheng Lu team). The vulnerability matrix method is only suitable for areas with rich earthquake damage data, and most areas in China are lack of detailed earthquake and earthquake damage information, so the vulnerability matrix method does not accord with city characteristics of most areas in China; and the earthquake response nonlinear course analysis method for the urban building complex has large building information data quantity required to be input for earthquake damage simulation of the urban building complex, and also has extremely wide types of building structures, to be capable of well simulating earthquake damage of the urban building complex. But it has extremely large data collection amount for the building complex, and also has extremely high requirement on configuration of a computer.

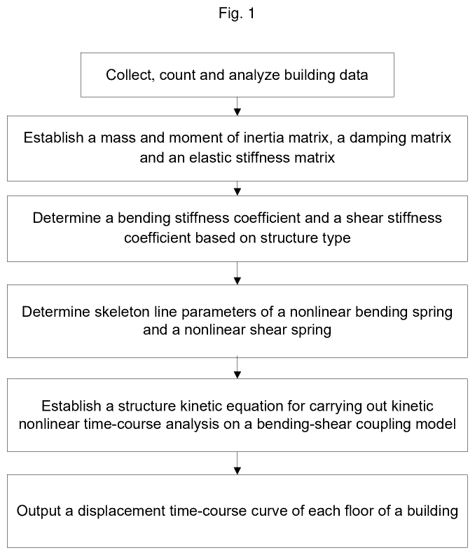

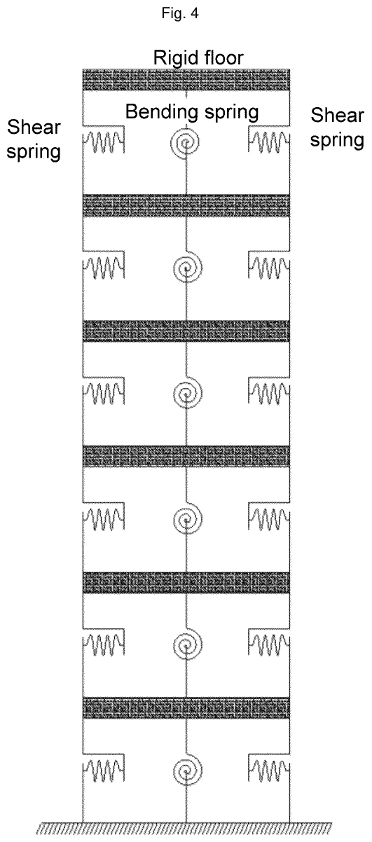

In order to solve the problems in the relevant art, the disclosure provides a method for establishing a multi-degree-of-freedom bending-shear coupling model with flow as shown in FIG. 1. Basic building information including structure type of a building, using area of a floor, geographical position information and floor height of the building is collected for establishing a multi-degree-of-freedom bending-shear coupling nonlinear analysis calculation model. A stiffness matrix, a mass matrix and a damping matrix required by a calculation model are determined by analyzing the structure type of the building, the floor height and the using area of the floor. The establishing method is carried out according to the following steps.
(1). Basic building information (structure type, using area of a floor, geographical position information, service life of the building and floor height of the building) of buildings in a building complex is collected; and the basic building information is processed by a probabilistic statistical method to obtain building information for calculation.
(2). Floor mass and floor moment of inertia of the building are calibrated by a mass and moment of inertia matrix based on the building information for calculation, namely, the building is divided based on actual natural floor of the building, it is assumed that the mass of each floor of the calculation model is concentrated on the slab, and then the slab is rigid and it is included in global rotation of the slab; therefore, each floor is simplified into a two-dimensional flat plate, two sides of an upper two-dimensional flat plate and a lower two-dimensional flat plate adjacent are connected through a shear spring, the centers of the upper two-dimensional flat plate and the lower two-dimensional flat plate adjacent are connected through a bending spring, as shown in FIG. 4; and the shear spring is configured to control a translational deformation characteristic of the calculation model, and the bending spring is configured to control a bending deformation characteristic of the calculation model. The calculation model is configured to exhibit an actual deformation characteristic and anti-seismic performance based on relative magnitudes of stiffness of the bending spring and stiffness of the shear spring under interaction of the bending spring and the shear spring.

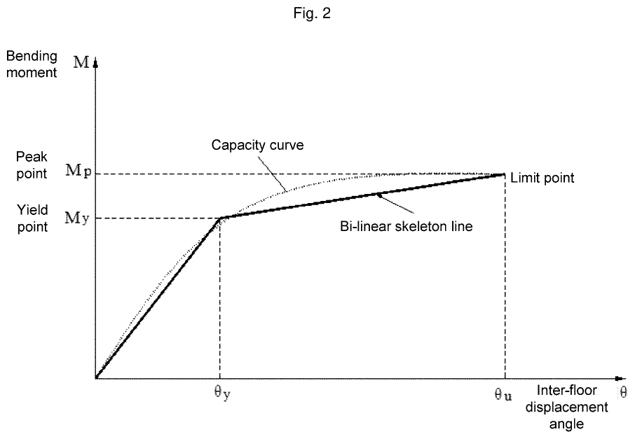

FIG. 2 is a diagram of a skeleton line and a capacity curve of a bending spring, with horizontal ordinates representing inter-floor displacement angle and vertical coordinates representing inter-floor bending moment. The skeleton line of the bending spring is a bi-linear skeleton line, the constitutive state of the bending spring is determined by the inter-floor bending moment and the inter-floor displacement angle, and the inter-floor reciprocating stress relationship adopts a single-parameter stress model.

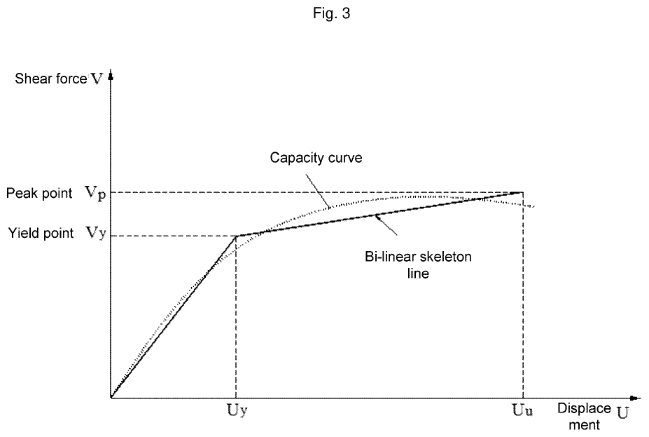

FIG. 3 is a diagram of a skeleton line and a capacity curve of a shear spring, with horizontal ordinates representing inter-floor displacement and vertical coordinates representing inter-storey shear force. The skeleton line of the shear spring is a bi-linear skeleton line, the constitutive state of the shear spring is determined by the inter-floor shear force and the inter-floor displacement, and the inter-floor reciprocating stress relationship adopts the single-parameter stress model.

Calibration for the constitutive models of the bending spring and the shear spring is carried out through division for structure types of existing buildings in a city, for example, 100 samples of structure types including a frame structure, a frame-shear wall structure, a shear wall structure and a frame-core tube structure are taken respectively, structural dynamic elastoplastic analysis is carried out, and shear stiffness, bending stiffness and nonlinear change rule of each floor of each structure type are counted.

The building is divided based on floor, wherein each building floor has corresponding bending stiffness and shear stiffness according to structural characteristic of the building floor. Based on different types of building structures, a proportion of the bending stiffness and a proportion of the shear stiffness of each floor of the building are different; and building mass of each floor is concentrated to the slab, the corresponding shear stiffness of each floor is replaced by two nonlinear shear springs, and the corresponding bending stiffness of each floor is replaced by a nonlinear bending spring, as shown in FIG. 4.

Global damping of the building is calibrated by a global damping matrix based on the building information for calculation; and the global damping matrix includes a damping matrix related to translation displacement, a damping matrix related to node rotation and a damping matrix related to corner translation.

Global elastic stiffness of the building is calibrated by a global elastic stiffness matrix based on the building information for calculation; the global elastic stiffness matrix includes a shear stiffness matrix [K_{f}] related to translation, a bending stiffness matrix [Kₛ] related to corner, and a bending-shear coupling stiffness matrix [K_{fs}] related to corner translation; and a corresponding amplitude modulation coefficient α of shear stiffness and a bending stiffness matrix coefficient β of bending stiffness of each floor of the building are determined based on the building information for calculation, and the weights of the shear stiffness matrix [Kf] and the bending stiffness matrix [Ks] in the global elastic stiffness matrix are controlled by α and β, to control a deformation characteristic of the building structure under the action of earthquake.

β and α may be obtained by statistical analysis of a large number of building structure models through machine learning, and the changes of different building structure forms are obvious, for example, the value of α/β of a single-floor masonry or frame structure is 5~10, a value of α/β of a high-rise frame structure is 2~4, and a value of α/β of a high-rise structure with a shear wall is 0.1~1.

The mass and moment of inertia matrix is

$$[ \begin{matrix}{M}_{hh} & 0 \\ 0 & {J}_{rr}\end{matrix} ] \qquad ( 1 )$$

As shown as formula (1), the mass and moment of inertia matrix is a diagonal matrix, an upper left corner of the diagonal matrix is a mass matrix Mₕₕ of the calculation model, and a lower right corner is a moment of inertia matrix Jᵣᵣ of the calculation model.

The formula (1) is expanded to obtain a formula (2):

$$[ \begin{matrix}{M}_{hh 1} & 0 & 0 & 0 & 0 & 0 \\ 0 & ⋱ & 0 & 0 & 0 & 0 \\ 0 & 0 & {M}_{hhn} & 0 & 0 & 0 \\ 0 & 0 & 0 & {J}_{rr 1} & 0 & 0 \\ 0 & 0 & 0 & 0 & ⋱ & 0 \\ 0 & 0 & 0 & 0 & 0 & {J}_{rrn}\end{matrix} ] \qquad ( 2 )$$

In formula (2), Mₕₕ₁ represents mass of a first floor of the building, Jᵣᵣ₁ represents moment of inertia of the first floor of the building, and so on.

The global damping matrix is

$$[ \begin{matrix}{C}_{hh} & {C}_{hr} \\ {C}_{hr}^{T} & {C}_{rr}\end{matrix} ] \qquad ( 3 )$$

In formula (3), Cₕₕ represents damping related to translation, and Cᵣᵣ represents damping related to corner; and Cₕᵣ represents damping related to bending-shear coupling, and

$${C}_{h r}^{T}$$

is transpose of Cₕᵣ, and also represents a damping matrix related to bending-shear coupling.

The global damping matrix is Rayleigh damping, and a derivation process is as the following formula:

$$[ C ] = [ \begin{matrix}{C}_{hh} & {C}_{hr} \\ {C}_{hr}^{T} & {C}_{rr}\end{matrix} ] = {α}_{0} [ \begin{matrix}{M}_{hh} & 0 \\ 0 & {J}_{rr}\end{matrix} ] + {α}_{1} [ \begin{matrix}{K}_{hh} & {K}_{hr} \\ {K}_{hr}^{T} & {K}_{rr}\end{matrix} ] \qquad ( 4 )$$

In formula (4):

$${α}_{0} = ξ [ 2 {ω}_{n} {ω}_{r} / ( {ω}_{n} + {ω}_{r} ) ] \\ {α}_{1} = ξ [ 2 / ( {ω}_{n} + {ω}_{r} ) ]$$

wherein ξ is a damping coefficient, ωₙ is a n-th modal structure period, and ωᵣ is a r-th modal structure period.

$$[ \begin{matrix}{K}_{hh} & {K}_{hr} \\ {K}_{hr}^{T} & {K}_{rr}\end{matrix} ]$$

in the formula (4) is the global elastic stiffness matrix; Kₕₕ is shear stiffness; Kᵣᵣ is bending stiffness; and Kₕᵣ is bending-shear coupling stiffness,

$${K}_{hr}^{T}$$

is transpose of Kₕᵣ,

$${K}_{hr}^{T}$$

also representing bending-shear coupling stiffness.

$$[ {K}_{hh} ] = [ \begin{matrix}{k}_{1} + {k}_{2} & - {k}_{2} & ⋯ & 0 \\ - {k}_{2} & {k}_{2} + {k}_{3} & - {k}_{3} & ⋮ \\ ⋮ & - {k}_{3} & ⋱ & - {k}_{n} \\ 0 & ⋯ & - {k}_{n} & {k}_{n}\end{matrix} ] \qquad ( 5 )$$

$$[ {K}_{hr} ] = [ \begin{matrix}\frac{- {L}_{1} {k}_{1}}{2} + \frac{{L}_{2} {k}_{2}}{2} & \frac{{L}_{2} {k}_{2}}{2} & ⋯ & 0 \\ - \frac{{L}_{2} {k}_{2}}{2} & - \frac{{L}_{2} {k}_{2}}{2} + \frac{{L}_{3} {k}_{3}}{2} & \frac{{L}_{3} {k}_{3}}{2} & ⋮ \\ ⋮ & - \frac{{L}_{3} {k}_{3}}{2} & ⋱ & \frac{{L}_{n} {k}_{n}}{2} \\ 0 & ⋯ & - \frac{{L}_{n} {k}_{n}}{2} & - \frac{{L}_{n} {k}_{n}}{2}\end{matrix} ] \qquad ( 6 )$$

$$[ {K}_{rr} ] = [ \begin{matrix}\frac{{L}_{1} {k}_{1}}{3} + \frac{{L}_{2} {k}_{2}}{3} & \frac{{L}_{2} {k}_{2}}{6} - \frac{EI}{L} & ⋯ & 0 \\ \frac{{L}_{2} {k}_{2}}{6} + \frac{EI}{L} & \frac{{L}_{2} {k}_{2}}{3} + \frac{{L}_{3} {k}_{3}}{3} & \frac{{L}_{3} {k}_{3}}{6} - \frac{EI}{L} & ⋮ \\ ⋮ & \frac{{L}_{3} {k}_{3}}{6} + \frac{EI}{L} & ⋱ & \frac{{L}_{n} {k}_{n}}{6} - \frac{EI}{L} \\ 0 & ⋯ & \frac{{L}_{n} {k}_{n}}{6} + \frac{EI}{L} & \frac{{L}_{n} {k}_{n}}{3} - \frac{EI}{L}\end{matrix} ] \qquad ( 7 )$$

In the formula (5)-(7), k₁=GA/L, G is a shear modulus, A is a section area of the shear spring, L is a length of the spring, E is an elastic modulus, and I is inertia moment.
Step 3). By taking the mass and moment of inertia matrix, the global damping matrix and the global elastic stiffness matrix as components, a kinetic equation of the multi-degree-of-freedom bending-shear coupling model is established:

$$[ \begin{matrix}{M}_{hh} & 0 \\ 0 & {J}_{rr}\end{matrix} ] \{ \begin{matrix}\ddot{u} \\ \ddot{θ}\end{matrix} \} + [ \begin{matrix}{C}_{hh} & {C}_{hr} \\ {C}_{hr}^{T} & {C}_{rr}\end{matrix} ] \{ \begin{matrix}\dot{u} \\ \dot{θ}\end{matrix} \} + [ \begin{matrix}α {K}_{hh} & {K}_{hr} \\ {K}_{hr}^{T} & β {K}_{rr}\end{matrix} ] \{ \begin{matrix}u \\ θ\end{matrix} \} = - [ \begin{matrix}{M}_{hh} & 0 \\ 0 & {J}_{rr}\end{matrix} ] \{ \begin{matrix}e \\ 0\end{matrix} \} {\ddot{u}}_{g} \qquad ( 8 )$$

In formula (8), α is amplitude modulation coefficient of the shear stiffness in the stiffness matrix; β is amplitude modulation coefficient of the bending stiffness in the stiffness matrix; ü is acceleration, unit: m/s²; \ddot{θ} is angular acceleration, unit: rad/s²; \dot{u} is velocity, unit: m/s; \dot{θ} is angular velocity, unit: rad/s; u is displacement, unit: m; θ is corner, unit: rad; and ü_{g} is earthquake acceleration, unit: gal.

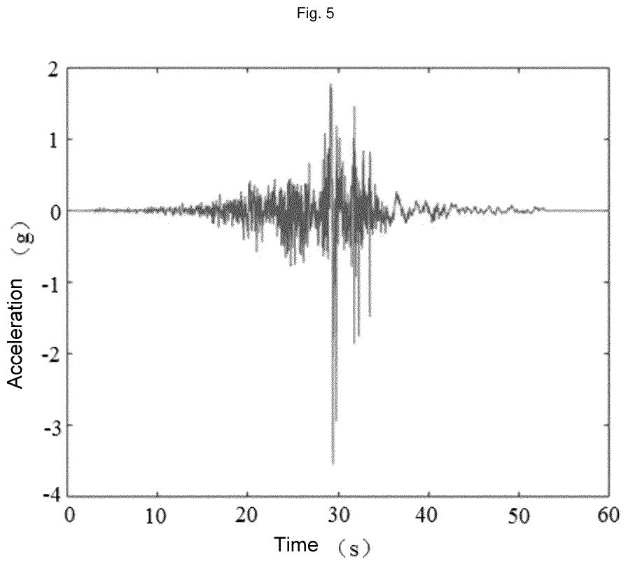

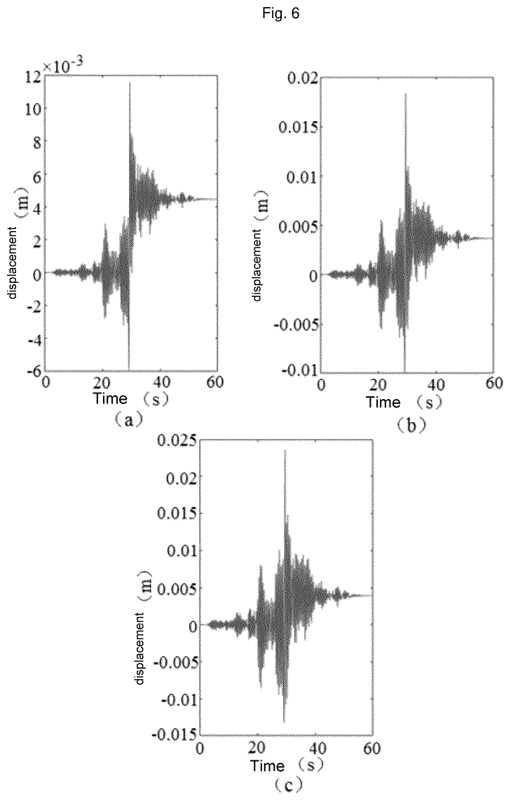

The multi-degree-of-freedom bending-shear coupling model is configured to rapidly analyze anti-seismic performance of the building, and earthquake damage simulation of a city or a village: acceleration time-course data is input for each building needing rapid analysis, and FIG. 5 is a curve chart of an earthquake time-curse. A structural dynamic equation is listed for the bending shear model corresponding to each building and dynamic nonlinear time-course analysis is carried out on each model under action of earthquake. The displacement history and floor corner history at each moment under the action of earthquake for each floor of each building is obtained through nonlinear time-history analysis, so that a curve chart of a displacement time-history of each floor of each building is obtained, and FIG. 6 is a curve chart of a displacement time-history of each floor of a three-floor building.

When nonlinear dynamic analysis is carried out, inter-floor restoring force of the calculation model at each moment is calculated based on a constitutive hysteresis model of the bending spring and the shear spring.

The inter-floor restoring force fs is provided partly by the restoring force fᵢₛ of the shear spring, and partly by the restoring force f_{IM} of the bending spring, namely, fₛ=fᵢₛ+f_{IM}.

The solving method of the restoring force of the shear spring is similar to that of the bending spring, but different in that the restoring force of the bending spring is obtained in that bending moment of the inter-floor bending spring divided by half of floor height is converted to equal storey shear force. In theory, the bending spring is a bending deformation part, for simulating a shear wall equivalently, of the bending beam, and then for the bending beam, in theory, EI/h represents bending stiffness g (unit: Nm). Δ^{θ} is inter-floor displacement angle, and then the bending moment born by the bending spring is Mf=(EI/h) (Δ^{θ})=g(Δ^{θ}).

The earthquake damage state, namely, the analysis result, of each floor of each building is obtained based on a nonlinear dynamic analysis calculation result, and the corresponding displacement time-course curve is obtained.

In the establishing method of the disclosure, the reliability of value of α/β is verified by

$$[ \begin{matrix}α {K}_{hh} & {K}_{hr} \\ {K}_{hr}^{T} & β {K}_{rr}\end{matrix} ] ,$$

and it is stable through verification of experiments.

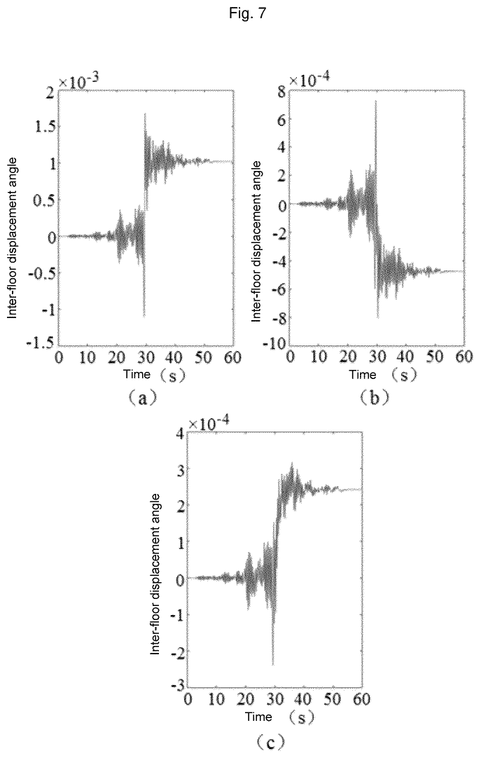

Through the calculation of formula (8), it may be obtained: time-history data related to inter-floor displacement of a building structure under action of earthquake as shown in FIG. 6 (FIG. 6a is displacement time-history data of a first floor, FIG. 6b is displacement time-history data of a second floor, and FIG. 6c is displacement time-history data of a third floor), and time-history data related to inter-floor displacement angle of a building structure under action of earthquake (FIG. 7a is time-history data of inter-floor displacement angle of a first floor, FIG. 7b is time-history data of inter-floor displacement angle of a second floor, and FIG. 7c is time-history data of inter-floor displacement angle of a third floor). Through inter-floor displacement and inter-floor displacement angle, analysis on anti-seismic performance of a building may be carried out, and simulation on earthquake damage of an urban building complex may be carried out.

A kinetic equation of the multi-degree-of-freedom bending-shear coupling model is solved by a central difference method. The central difference method is to replace derivation of displacement or corner to time by finite difference, and by adopting equal time step Δt, the central difference between velocity and acceleration and between angular velocity and angular acceleration at moment i is approximately:
velocity at moment i

$${\dot{u}}_{i} = \frac{{u}_{i + 1} - {u}_{i - 1}}{2 Δ t} \qquad ( 9 )$$

acceleration at moment i

$${\ddot{u}}_{i} = \frac{{u}_{i + 1} - 2 {u}_{i} + {u}_{i - 1}}{Δ {t}^{2}} \qquad ( 10 )$$

angular velocity at moment i

$${\dot{θ}}_{i} = \frac{{θ}_{i + 1} - {θ}_{i - 1}}{2 Δ t} \qquad ( 11 )$$

angular acceleration at moment i

$${\ddot{θ}}_{i} = \frac{{θ}_{i + 1} - 2 {θ}_{i} + {θ}_{i - 1}}{Δ {t}^{2}} \qquad ( 12 )$$

Formula (8) is decomposed to obtain:

$$[ {M}_{hh} ] \{ \ddot{u} \} + [ {C}_{hh} ] \{ \dot{u} \} + [ {C}_{hr} ] \{ \dot{θ} \} + [ α {K}_{hh} ] \{ u \} + [ {K}_{hr} ] \{ θ \} = - [ {M}_{hh} ] \{ e \} {\ddot{u}}_{g} \qquad ( 13 )$$

$$[ {J}_{rr} ] \{ \ddot{θ} \} + [ {C}_{hr}^{T} ] \{ \dot{u} \} + [ {C}_{rr} ] \{ \dot{θ} \} + [ {K}_{hr}^{T} ] \{ u \} + [ β {K}_{rr} ] \{ θ \} = 0 \qquad ( 14 )$$

Formula (9), formula (10) and formula (11) are substituted into formula (13) to obtain formula (15):

$$[ {M}_{hh} ] \{ \frac{{u}_{i + 1} - 2 {u}_{i} + {u}_{i - 1}}{Δ {t}^{2}} \} + [ {C}_{hh} ] \{ \frac{{u}_{i + 1} - {u}_{i - 1}}{2 Δ t} \} + [ {C}_{hr} ] \{ \frac{{θ}_{i + 1} - {θ}_{i - 1}}{2 Δ t} \} + [ α {K}_{hh} ] \{ {u}_{i} \} + [ {K}_{hr} ] \{ {θ}_{i} \} = - [ {M}_{hh} ] \{ e \} {\ddot{u}}_{g} \qquad ( 15 )$$

formula (9), formula (11) and formula (12) are substituted into formula (14) to obtain formula (16):

$$[ {J}_{rr} ] \{ \frac{{θ}_{i + 1} - 2 {θ}_{i} + {θ}_{i - 1}}{Δ {t}^{2}} \} + [ {C}_{hr}^{T} ] \{ \frac{{u}_{i + 1} - {u}_{i - 1}}{2 Δ t} \} + [ {C}_{rr} ] \{ \frac{{θ}_{i + 1} - {θ}_{i - 1}}{2 Δ t} \} + [ {K}_{hr}^{T} ] \{ {u}_{i} \} + [ β {K}_{rr} ] \{ {θ}_{i} \} = 0 \qquad ( 16 )$$

In the formula: uᵢ is displacement at moment i, unit: m; uᵢ₋₁ is displacement at moment i−1, unit: m; uᵢ₊₁ is displacement at moment i+1, unit: m; θᵢ is corner at moment i, unit: rad; θᵢ₋₁ is corner at moment i−1, unit: rad; and θᵢ₊₁ is corner at moment i+1, unit: rad.

Displacement and corner time-history may be solved by simultaneously solving equations (16) and (15).

1. A method for establishing a multi-degree-of-freedom bending-shear coupling nonlinear analysis model, comprising the following steps:
step 1) collecting basic building information of buildings in a building complex, and processing the basic building information by a probabilistic statistical method to obtain building information for calculation;
step 2) calibrating floor mass and floor moment of inertia of the building by a mass and moment of inertia matrix based on the building information for calculation, simplifying each floor of the building into a two-dimensional flat plate, connecting two sides of an upper flat plate and a lower flat plate adjacent through a shear spring, and connecting centers of the upper flat plate and the lower flat plate adjacent through a bending spring to obtain a calculation model; the shear spring is configured to control a translational deformation characteristic of a physical model, and the bending spring is configured to control a bending deformation characteristic of the physical model; and the calculation model is configured to exhibit an actual deformation characteristic and anti-seismic performance based on relative magnitudes of bending stiffness of the bending spring and shear stiffness of the shear spring under interaction of the bending spring and the shear spring;
dividing the building based on floor, wherein each building floor has corresponding bending stiffness and shear stiffness based on a structural characteristic of the building floor; based on different types of the building structure, a proportion of the bending stiffness and a proportion of the shear stiffness of each building floor are different; and concentrating building mass of each floor onto the slab, replacing the corresponding shear stiffness of each floor by two nonlinear shear springs, and replacing the corresponding bending stiffness of each floor by one nonlinear bending spring;
calibrating global damping of the building by a global damping matrix based on the building information for calculation; the global damping matrix comprises a damping matrix related to translation displacement, a damping matrix related to node rotation and a damping matrix related to corner translation;
calibrating global elastic stiffness of the building by a global elastic stiffness matrix based on the building information for calculation; the global elastic stiffness matrix comprises a shear stiffness matrix related to translation, a bending stiffness matrix related to corner and a bending-shear coupling stiffness matrix related to corner translation;
determining a corresponding shear stiffness matrix coefficient α and a bending stiffness matrix coefficient β of each floor of the building based on the building information for calculation, and a weight of the shear stiffness matrix and a weight of bending stiffness matrix in the global elastic stiffness matrix are controlled by α and β;
step 3) by taking the mass and moment of inertia matrix, the global damping matrix and the global elastic stiffness matrix as components, establishing a kinetic equation of the multi-degree-of-freedom bending-shear coupling model:
$$[ \begin{matrix}{M}_{hh} & 0 \\ 0 & {J}_{rr}\end{matrix} ] \{ \begin{matrix}\ddot{u} \\ \ddot{θ}\end{matrix} \} + [ \begin{matrix}{C}_{hh} & {C}_{hr} \\ {C}_{hr}^{T} & {C}_{rr}\end{matrix} ] \{ \begin{matrix}\dot{u} \\ \dot{θ}\end{matrix} \} + [ \begin{matrix}α {K}_{hh} & {K}_{hr} \\ {K}_{hr}^{T} & β {K}_{rr}\end{matrix} ] \{ \begin{matrix}u \\ θ\end{matrix} \} = - [ \begin{matrix}{M}_{hh} & 0 \\ 0 & {J}_{rr}\end{matrix} ] \{ \begin{matrix}e \\ 0\end{matrix} \} {\ddot{u}}_{g} \qquad ( 8 )$$
in formula (8), a is amplitude modulation coefficient of the shear stiffness in the stiffness matrix; β is amplitude modulation coefficient of the bending stiffness in the stiffness matrix; ü is acceleration, unit: m/s²; \dot{θ} is angular acceleration, unit: rad/s²; \dot{u} is velocity, unit: m/s; \dot{θ} is angular velocity, unit: rad/s; u is displacement, unit: m; θ is corner, unit: rad; and ü_{g} is earthquake acceleration, unit: gal.

2. The method for establishing a multi-degree-of-freedom bending-shear coupling nonlinear analysis model as claimed in claim 1, wherein in the step 1), the basic building information comprises a structure type, a using area of floor and a floor height of the building.

3. The method for establishing a multi-degree-of-freedom bending-shear coupling nonlinear analysis model according to claim 1, wherein in the step 2), calibrating the floor mass and the floor moment of inertia of the building by a mass and moment of inertia matrix comprises: establishing a corresponding multi-degree-of-freedom bending-shear coupling calculation model based on information of an actual building, dividing the building based on an actual natural floor of the building, assuming that the mass of each floor of the calculation model is concentrated on the slab, and the slab is rigid and it is included in global rotation of the slab.

4. The method for establishing a multi-degree-of-freedom bending shear coupling nonlinear analysis model as claimed in claim 1, wherein a skeleton line of the bending spring is a bi-linear skeleton line, constitutive state of the bending spring is determined by inter-floor bending moment and an inter-floor displacement angle, and an inter-floor reciprocating stress relationship adopts a single-parameter stress model;
a skeleton line of the shear spring is a bi-linear skeleton line, constitutive state of the shear spring is determined by inter-floor shear force and inter-floor displacement, and inter-floor reciprocating stress relationship adopts the single-parameter stress model.

5. The method for establishing a multi-degree-of-freedom bending-shear coupling nonlinear analysis model as claimed in claim 1, wherein the method comprises: dividing structure types of existing buildings in a city, respectively taking 100 samples to perform structural dynamic elastoplastic analysis, respectively counting shear stiffness and bending stiffness of each floor of the building with each structure type and nonlinear change rule of the shear stiffness and the bending stiffness, to calibrate for the constitutive model of the bending spring and the constitutive model of the shear spring.

6. The method for establishing a multi-degree-of-freedom bending-shear coupling nonlinear analysis model as claimed in claim 1, wherein in the step 2) comprises: obtaining β and α through statistical analysis of a large number of building structure models through machine learning, a value of α/β of a single-story masonry or frame structure is 5~10, a value of α/β of a high-rise frame structure is 2~4, and a value of α/β of a high-rise structure with a shear wall is 0.1~1;
the mass and moment of inertia matrix is:
$$[ \begin{matrix}{M}_{hh} & 0 \\ 0 & {J}_{rr}\end{matrix} ] \qquad ( 1 )$$
the mass and moment of inertia matrix is a diagonal matrix, an upper left corner of the diagonal matrix is a mass matrix Mₕₕ of the calculation model, and a lower right corner is a moment of inertia matrix Jᵣᵣ of the calculation model;
expanding the formula (1) to obtain a formula (2):
$$[ \begin{matrix}{M}_{hh 1} & 0 & 0 & 0 & 0 & 0 \\ 0 & ⋱ & 0 & 0 & 0 & 0 \\ 0 & 0 & {M}_{hhn} & 0 & 0 & 0 \\ 0 & 0 & 0 & {J}_{rr 1} & 0 & 0 \\ 0 & 0 & 0 & 0 & ⋱ & 0 \\ 0 & 0 & 0 & 0 & 0 & {J}_{rrn}\end{matrix} ] \qquad ( 2 )$$
in formula (2), Mₕₕ₁ represents mass of a first floor of the building, Jᵣᵣ₁ represents moment of inertia of the first floor of the building, and so on;
the global damping matrix is:
$$[ \begin{matrix}{C}_{hh} & {C}_{hr} \\ {C}_{hr}^{T} & {C}_{rr}\end{matrix} ] \qquad ( 3 )$$
in formula (3), Cₕₕ represents damping related to translation; Cᵣᵣ represents damping related to corner; and Cₕᵣ and C^{T}ₕᵣ represents damping related to bending-shear coupling;
the global damping matrix is Rayleigh damping, and a derivation process is as the following formula:
$$[ C ] = [ \begin{matrix}{C}_{hh} & {C}_{hr} \\ {C}_{hr}^{T} & {C}_{rr}\end{matrix} ] = {α}_{0} [ \begin{matrix}{M}_{hh} & 0 \\ 0 & {J}_{rr}\end{matrix} ] + {α}_{1} [ \begin{matrix}{K}_{hh} & {K}_{hr} \\ {K}_{hr}^{T} & {K}_{rr}\end{matrix} ] \qquad ( 4 )$$
in formula (4):
$${α}_{0} = ξ [ 2 {ω}_{n} {ω}_{r} / ( {ω}_{n} + {ω}_{r} ) ]$$
$${α}_{1} = ξ [ 2 / ( {ω}_{n} + {ω}_{r} ) ]$$
wherein ξ is a damping coefficient, ωₙ is the a n-th modal structure period, and ωᵣ is a r-th modal structure period;
$$[ \begin{matrix}{K}_{hh} & {K}_{hr} \\ {K}_{hr}^{T} & {K}_{rr}\end{matrix} ]$$
in the formula (4) is the global elastic stiffness matrix; Kₕₕ is shear stiffness; Kᵣᵣ is bending stiffness; Kₕᵣ is bending-shear coupling stiffness, and K^{T}ₕᵣ is transpose of Kₕᵣ, K^{T}ₕᵣ representing bending-shear coupling stiffness;
$$[ {K}_{hh} ] = [ \begin{matrix}{k}_{1} + {k}_{2} & - {k}_{2} & … & 0 \\ - {k}_{2} & {k}_{2} + {k}_{3} & - {k}_{3} & ⋮ \\ ⋮ & - {k}_{3} & ⋱ & - {k}_{n} \\ 0 & … & - {k}_{n} & {k}_{n}\end{matrix} ] \qquad ( 5 )$$
$$[ {K}_{hr} ] = [ \begin{matrix}\frac{- {L}_{1} {k}_{1}}{2} + \frac{{L}_{2} {k}_{2}}{2} & \frac{{L}_{2} {k}_{2}}{2} & … & 0 \\ - \frac{{L}_{2} {k}_{2}}{2} & - \frac{{L}_{2} {k}_{2}}{2} + \frac{{L}_{3} {k}_{3}}{2} & \frac{{L}_{3} {k}_{3}}{2} & ⋮ \\ ⋮ & \frac{- {L}_{3} {k}_{3}}{2} & ⋱ & \frac{{L}_{n} {k}_{n}}{2} \\ 0 & … & - \frac{{L}_{n} {k}_{n}}{2} & - \frac{{L}_{n} {k}_{n}}{2}\end{matrix} ] \qquad ( 6 )$$
$$[ {K}_{rr} ] = [ \begin{matrix}\frac{{L}_{1} {k}_{1}}{3} + \frac{{L}_{2} {k}_{2}}{3} & \frac{{L}_{2} {k}_{2}}{6} - \frac{EI}{L} & … & 0 \\ \frac{{L}_{2} {k}_{2}}{6} + \frac{EI}{L} & \frac{{L}_{2} {k}_{2}}{3} + \frac{{L}_{3} {k}_{3}}{3} & \frac{{L}_{3} {k}_{3}}{6} - \frac{EI}{L} & ⋮ \\ ⋮ & \frac{{L}_{3} {k}_{3}}{6} + \frac{EI}{L} & ⋱ & \frac{{L}_{n} {k}_{n}}{6} - \frac{EI}{L} \\ 0 & … & \frac{{L}_{n} {k}_{n}}{6} + \frac{EI}{L} & \frac{{L}_{n} {k}_{n}}{3} - \frac{EI}{L}\end{matrix} ] \qquad ( 7 )$$
in the formula (5)-(7), k₁=GA/L, G is a shear modulus, A is a section area of the shear spring, L is a length of the spring, E is an elastic modulus, and I is inertia moment.

7. A method for applying a multi-degree-of-freedom bending-shear coupling nonlinear analysis model, wherein the multi-degree-of-freedom bending-shear coupling nonlinear analysis model established by the method for establishing a multi-degree-of-freedom bending-shear coupling nonlinear analysis model according to claim 1.

8. The method as claimed in claim 7, wherein the multi-degree-of-freedom bending-shear coupling nonlinear analysis model is configured to rapidly analyze anti-seismic performance of a building, earthquake damage simulation of a city and earthquake damage simulation of a village:
inputting acceleration time-course data for each building needing rapid analysis, listing a structural dynamic equation for the bending shear model corresponding to each building and carrying out dynamic nonlinear time-course analysis on each model under action of earthquake;
obtaining displacement history and floor corner history at each moment under the action of earthquake for each floor of each building through nonlinear time-history analysis, and obtaining a curve chart of a displacement time-course of each floor of each building;
when nonlinear dynamic analysis is carried out, determining inter-floor restoring force of the calculation model at each moment based on a constitutive hysteresis model of the bending spring and the shear spring; and obtaining earthquake damage state of each floor of each building based on a nonlinear dynamic analysis calculation result.
